(19) United States
(12) Patent Application Publication
(10) Pub. No.: US 2011/0277470 A1
(43) Pub. Date: Nov. 17, 2011

(54) Solar Thermal Power Plant and Dual-Purpose Pipe for Use Therewith

(76) Inventors: Shay Benyaminy, Modiin (IL); Avraham Brenmiller, Tel Aviv (IL)

(21) Appl. No.: 13/127,802

(22) PCT Filed: Nov. 5, 2009
(86) PCT No.: PCT/IL09/01036

§ 371 Date: Jul. 26, 2011

Related U.S. Application Data
(60) Provisional application No. 61/193,207, filed on Nov. 5, 2008.

(51) Int. Cl. F03G 6/00; F16L 9/18; F24J 2/34; F24J 2/30; F24J 2/12

(52) U.S. Cl. 60/641.8; 126/643; 126/694; 126/617; 138/114

(57) ABSTRACT

A solar thermal power plant is provided. The solar thermal power plant includes a thermal-electric power plant and a solar collection system in communication therewith to provide heat thereto for driving its operation and being designed to facilitate capture of thermal energy of incident solar radiation by a thermal transfer fluid flowing therethrough for providing the heat. The solar collection system includes one or more solar collectors configured for the capture. The solar collection system further includes at least one dual-purpose pipe configured for carrying heated thermal transfer fluid to the thermal-electric power plant, the dual-purpose pipe including a supply chamber for carrying the thermal transfer fluid therethrough, and at least one storage element in thermal communication with and in fluid isolation from the supply chamber, and being configured for storing thermal energy for providing heat for driving operation of the thermal-electric power plant.

### FIELD OF THE INVENTION

This invention relates to solar thermal power plant. In particular, it relates to solar thermal power plants configured for storage of thermal energy.

### BACKGROUND OF THE INVENTION

Amid concerns over global warming, and forecasts of both the depletion of non-renewable energy sources and rising power demand, suppliers of energy are increasingly seeking alternative primary sources of energy. One such source of energy is solar energy, and one way of utilizing solar energy is with a solar thermal power plant.

One type of solar power plant utilizes a “radiation concentrator collector” which concentrates the solar radiation by focusing it onto a smaller area, e.g., using mirrored surfaces or lenses. In this system, a reflector, which is typically parabolic, receives and reflects (focuses) incoming solar radiation onto a radiation absorber, which is formed as a tube. The tube radiation absorber is concentrically surrounded by a treated glass enclosure tube to limit the loss of heat. The collector system further includes means to track the sun.

The tube radiation absorber is made of metal with a coating having a high solar radiation absorption coefficient to maximize the energy transfer imparted by the solar radiation reflecting off the reflector. A thermal transfer fluid, which is typically a liquid such as oil, flows within the tube radiation absorber.

The thermal energy is transported by the thermal transfer fluid to power a thermal-electric power plant to drive one or more power-generation systems thereof, in order to generate electricity in a conventional way, e.g., by coupling the axle of each of the turbines to an electric generator. One such example of a thermal-electric power plant is a steam-electric power plant, which uses thermal energy provided thereto to produce steam to drive turbines thereof, which in turn drive a generator, thus generating electricity.

In addition to using direct and/or concentrated solar radiation, as described above, to heat the thermal transfer fluid on an as-needed basis, some of the thermal energy may be transferred from the thermal transfer fluid to a thermal storage medium, such as molten salt, for storage. The stored thermal energy may be used at a later point, when insufficient or no solar radiation is available, to heat the thermal transfer fluid, enabling to drive the turbines of the thermal-electric power plant.

### SUMMARY OF THE INVENTION

According to one aspect of the present invention, there is provided a solar thermal power plant comprising a thermal-electric power plant and a solar collection system in communication therewith to provide heat thereto for driving its operation and being designed to facilitate capture of thermal energy of incident solar radiation by a thermal transfer fluid flowing therethrough for providing the heat; the solar collection system comprising:
one or more solar collectors configured for the capture; and
at least one dual-purpose pipe configured for carrying heated thermal transfer fluid to the thermal-electric power plant, the dual-purpose pipe comprising a supply chamber for carrying the thermal transfer fluid therethrough, and at least one storage element in thermal communication with and in fluid isolation from the supply chamber, and being configured for storing thermal energy for providing heat for driving operation of the thermal-electric power plant.

The storage element is designed to store an amount of thermal energy which is sufficient for driving operation of the thermal-electric power plant for a significant amount of time, for example, several hours for night-time operation. Specifically, it may be designed to store enough thermal energy that thermally depleted thermal transfer fluid from the thermal-electric power plant (i.e., whose thermal energy has been used to drive the thermal-electric power plant) can be heated by the storage element to a sufficient temperature to provide heat for driving its operation further. For example, the amount of thermal energy storage of the storage element within the pipe may be sufficient to raise an amount of thermal transfer fluid, which is equal to the volume of thermal transfer fluid within the solar collection system, from its temperature when thermally depleted to a temperature which is sufficient to drive the operation of the thermal-electric power plant, or to the temperature at which it is typically heated within the solar collectors.

The solar thermal power plant may be configured to selectively operate in one of:
a direct solar mode, wherein thermal transfer fluid is heated within the solar collection system by incident solar radiation, the heated thermal transfer fluid flowing therefrom via the supply chamber to the thermal-electric power plant to provide heat thereto to drive its operation, and used to heat the storage element; and
a solar discharge mode, wherein thermal transfer fluid is heated within the supply chamber by the storage element.

The solar thermal power plant may be configured to facilitate heating of the storage element by the thermal transfer fluid flowing to the thermal-electric power plant via the supply chamber.

The supply chamber and the storage element may be arranged concentrically. For example, the storage element may be encircled by the supply chamber, or the supply chamber may be encircled by the storage element.

The dual-purpose pipe may comprise a plurality of storage elements disposed within a single supply chamber.

Each of the supply and storage elements may extend along substantially the entire length of the dual-purpose pipe.

The dual-purpose pipe may be thermally insulated.

The solar collectors may comprise parabolic solar concentrators having a tube radiation absorber for carrying thermal transfer fluid to be heated by the captured incident solar radiation. The tube radiation absorber may be in fluid communication with the dual-purpose pipe, or it may constitute the dual-purpose pipe.

The dual-purpose pipe may be a header pipe configured for carrying heated thermal transfer fluid from the solar collection system to the thermal-electric power plant.

The solar thermal power plant may further comprise at least one bypass pipe and control valves selectively configurable for bringing the solar collectors to fluid communication with the thermal-electric power plant via the bypass pipe such that heated thermal transfer fluid can be carried from the solar collectors to the thermal-electric power plant in thermal isolation from the storage element.

The storage element may comprise a storage chamber comprising a thermal storage medium therein in fluid isolation from said supply chamber. The thermal storage medium may be selected from a group comprising sensible heat-storage material, phase-change storage material, and thermo-chemical storage media.

The storage element may be in communication with an external storage tank containing a thermal storage medium to facilitate exchange of thermal energy therewith. The storage element may be in fluid or thermal communication with the external storage tank.

According to another aspect of the present invention, there is provided a dual-purpose pipe for use with a solar thermal power plant comprising a thermal-electric power plant and a solar collection system in communication therewith to provide heat thereto for driving its operation and being designed to facilitate capturing of incident solar radiation by a thermal transfer fluid flowing therethrough for providing the heat; the solar collection system comprising one or more solar collectors configured for the capturing; the dual-purpose pipe being configured for carrying heated thermal transfer fluid to the thermal-electric power plant and comprising a supply chamber for carrying the thermal transfer fluid therethrough, and at least one storage element in thermal communication with and in fluid isolation from the supply chamber, and being configured for storing thermal energy for providing heat for driving operation of the thermal-electric power plant.

The supply chamber and the storage element may be arranged concentrically. For example, the storage element may be encircled by the supply chamber, or the supply chamber may be encircled by the storage element.

The dual-purpose pipe may comprise a plurality of storage elements disposed within a single supply chamber.

Each of the supply and storage elements may extend along substantially the entire length of the dual-purpose pipe.

The dual-purpose pipe may be thermally insulated.

The dual-purpose pipe may be a header pipe configured for carrying heated thermal transfer fluid from the solar collection system to the thermal-electric power plant. The solar thermal power plant may further comprise at least one bypass pipe and control valves selectively configurable for bringing the solar collectors to fluid communication with the thermal-electric power plant via the bypass pipe such that heated thermal transfer fluid can be carried from the solar collectors to the thermal-electric power plant in thermal isolation from the storage element.

The storage element may comprise a storage chamber comprising a thermal storage medium therein in fluid isolation from said supply chamber. The thermal storage medium may be selected from a group comprising sensible heat-storage material, phase-change storage material, and thermo-chemical storage media.

The storage element may be in communication with an external storage tank containing a thermal storage medium to facilitate exchange of thermal energy therewith. The storage element may be in fluid or thermal communication with the external storage tank.

According to a further aspect of the present invention, there is provided a method of generating electricity, comprising:
providing a solar thermal power plant comprising a thermal-electric power plant and a solar collection system in communication therewith to provide heat thereto for driving its operation and being designed to facilitate capture of thermal energy of incident solar radiation by a thermal transfer fluid flowing therethrough for providing the heat; the solar collection system comprising one or more solar collectors configured for the capture; and at least one dual-purpose pipe configured for carrying heated thermal transfer fluid to the thermal-electric power plant, the dual-purpose pipe comprising a supply chamber for carrying the thermal transfer fluid therethrough, and at least one storage element in thermal communication with and in fluid isolation from the supply chamber, and being configured for storing thermal energy for providing heat for driving operation of the thermal-electric power plant;
in a direct solar mode, causing the thermal transfer fluid to flow from the solar collection system to the thermal-electric power plant via the supply chamber, utilizing thermal energy captured within the solar collectors to heat the storage element and drive operation of the thermal-electric power plant; and
in a solar discharge mode, causing the thermal transfer fluid to flow through the supply chamber, utilizing the heated storage element to heat the thermal transfer fluid for driving operation of the thermal-electric power plant.

The solar thermal power plant may further comprise at least one bypass pipe and control valves selectively configurable for bringing the solar collectors to fluid communication with the thermal-electric power plant via the bypass pipe such that heated thermal transfer fluid can be carried from the solar collectors to the thermal-electric power plant in thermal isolation from the storage element, the method further comprising selectively diverting thermal transfer fluid from the supply chamber to flow to the thermal-electric power plant via the bypass pipe.

The solar thermal power plant may be configured to facilitate heating of the storage element by the thermal transfer fluid flowing to the thermal-electric power plant via the supply chamber.

The supply chamber and the storage element may be arranged concentrically. For example, the storage element may be encircled by the supply chamber, or the supply chamber may be encircled by the storage element.

The dual-purpose pipe may comprise a plurality of storage elements disposed within a single supply chamber.

Each of the supply and storage elements may extend along substantially the entire length of the dual-purpose pipe.

The dual-purpose pipe may be thermally insulated.

The solar collectors may comprise parabolic solar concentrators having a tube radiation to absorber for carrying thermal transfer fluid to be heated by the captured incident solar radiation.

The tube radiation absorber may be in fluid communication with the dual-purpose pipe, or it may constitute the dual-purpose pipe.

The dual-purpose pipe may be a header pipe configured for carrying heated thermal transfer fluid from the solar collection system to the thermal-electric power plant.

The storage element may comprise a storage chamber comprising a thermal storage medium therein in fluid isolation from said supply chamber. The thermal storage medium may be selected from a group comprising sensible heat-storage material, phase-change storage material, and thermo-chemical storage media.

The storage element may be in communication with an external storage tank containing a thermal storage medium to facilitate exchange of thermal energy therewith. The storage element may be in fluid or thermal communication with the external storage tank.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is schematic illustration of a solar thermal power plant according to the present invention;

FIGS. 2 through 5 are cross-sectional views of a main supply header pipe taken transverse to its length according to examples of the present invention;

FIGS. 6A and 6B are cross-sectional views of a main supply header pipe taken along its length according to further examples of the present invention; and

FIG. 7 is schematic illustration of a solar thermal power plant according to a modification of the present invention.

### DETAILED DESCRIPTION OF EMBODIMENTS

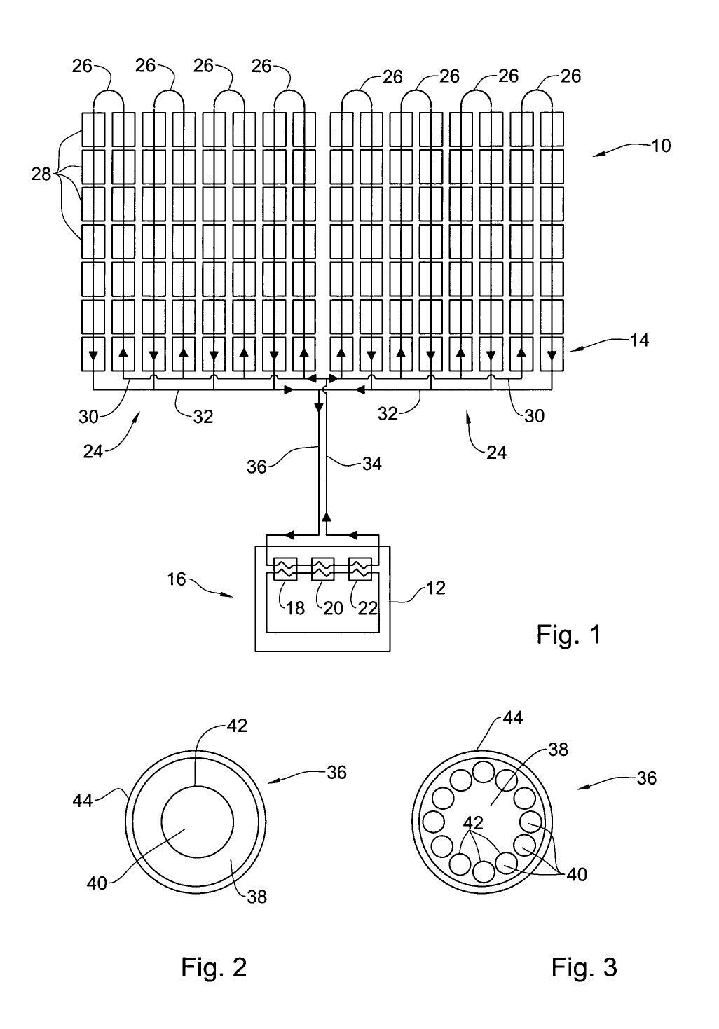

As illustrated in FIG. 1, there is provided a solar thermal power plant, generally indicated at 10. The plant 10 comprises a thermal-electric power plant 12 which utilizes heat to drive its operation to produce electricity, and a solar collection system 14 for providing the heat therefor. The solar thermal power plant may be designed in accordance with that described in PCT/IL2009/000899, filed on Sep. 15, 2009, to the present applicant, the disclosure of which is incorporated herein by reference.

The thermal-electric power plant 12 comprises elements which are typically found within such a plant and which are well-known, such as one or more turbines, a condenser, feedwater heaters, pumps, etc. (individual elements of the thermal-electric power plant are not illustrated). The turbines are coupled to an electrical generator for generating electricity, as is well known. The thermal-electric power plant 12 may be designed in accordance with that described in WO 2009/034577, filed on Sep. 11, 2008, to the present applicant, the disclosure of which is incorporated herein by reference.

The thermal-electric power plant 14 further comprises a steam generation system 16 comprising a steam generation train having three heat exchangers, a pre-heater 18, an evaporator 20, and a super-heater 22. The steam generation train is configured to transfer heat from an outside source (in this case, the solar collection system 14) to working fluid of the thermal-electric power plant 12, so that it can reach the elevated temperature and pressure required to optimally drive the turbines thereof. The steam generation train may further comprise an optional reheater (not illustrated).

The solar collection system 14 comprises one or more solar fields 24, which are configured to capture heat from sunlight impinging thereon and carry it to the steam generation system 14 of the thermal-electric power plant 12 for driving its operation. The solar fields 24 comprise one or more tube radiation absorbers 26 and a plurality of trough collectors 28, such as single-axis parabolic reflectors. Alternatively, any suitable means for concentrating solar radiation, such as Fresnel collectors, may be provided. The tube radiation absorbers 26 contain a thermal transfer fluid therein, such as oil (phenyls) which are commercially available, such as under the trade name Therminol® VP-1, Dowtherm™, etc. According to different embodiments, the thermal transfer fluid may also be one of steam/water, molten salts, carbon dioxide, and helium. The thermal transfer fluid, according to any of the embodiments, is heated within the tube radiation absorbers 26 upon their exposure to direct solar radiation and solar radiation concentrated by the trough collectors 28. Thus, the thermal transfer fluid is heated as it flows through the tube radiation absorbers 26. Solar collection systems of this type are provided, inter alia, by Solel Solar Systems, Ltd. (Israel).

It will be appreciated that while the solar collection system 24 is illustrated in FIG. 1 as comprising two solar fields, any suitable number of fields may be provided without departing from the spirit and scope of the present invention, mutatis mutandis.

Each of the tube radiation absorbers 26 constitutes a loop, which carries thermal transfer fluid through a solar field 24 for heating. Each loop is connected, at an upstream end thereof, to a local return header pipe 30, which is configured to carry thermally depleted thermal transfer fluid from the thermal-electric power plant 12 to the solar field 24, and, at a downstream end thereof, to a local supply header pipe 32, which is configured for carrying heated thermal transfer fluid from the solar collection system 14. The solar collection system 14 further comprises a main return header pipe 34, which is configured for carrying thermally depleted thermal transfer fluid from the thermal-electric power plant 12 thereto via the local return header pipe 30, and a main supply header pipe 36, which is configured for carrying heated thermal transfer fluid from the solar collection system to the thermal-electric power plant for driving its operation.

The direction of flow of thermal transfer fluid through each of the tube radiation absorbers 26, local return header pipes 30, local supply header pipes 32, main return header pipe 34, and main supply header pipe 36 is indicated by arrows in FIG. 1.

As illustrated in FIG. 2, main supply header pipe 36 may be provided as a dual-purpose pipe. As such, it comprises a supply chamber 38, configured for carrying thermal transfer fluid therethrough, and a storage element 40 disposed concentrically therein (i.e., encircled by the supply chamber), which may carry a thermal storage medium therein. The thermal storage medium may be any appropriate material for storing thermal energy, such as molten salt (e.g., comprising a mixture of sodium nitrate and potassium nitrate), sensible heat-storage material, phase-change storage material, thermo-chemical storage media, etc. The supply chamber 38 and storage element 40 are fluidly isolated by a thermally permeable wall 42 made of a thermally conductive material, such as stainless steel, or any other suitable material or combination of materials. In addition, the main supply header pipe 36 may be surrounded by a vacuum tube 44, or any other appropriate means of thermal insulation.

It will be appreciated that while herein the description of the storage element 40 generally refers to a hollow chamber carrying a thermal storage medium therein, any thermal storage element may be provided without deviating from the scope of the invention, mutatis mutandis.

The thermal storage medium is useful for storing thermal energy during operation of the plant 10, drawing a small portion of the thermal energy captured and carried by the thermal transfer fluid. During periods of low or no incident solar radiation (e.g., in the event of heavy cloud cover, inclement weather, or at night), thermal energy stored in the thermal storage medium is used to heat the thermal transfer fluid, which may then be used to drive the operation of the thermal-electric power plant 12.

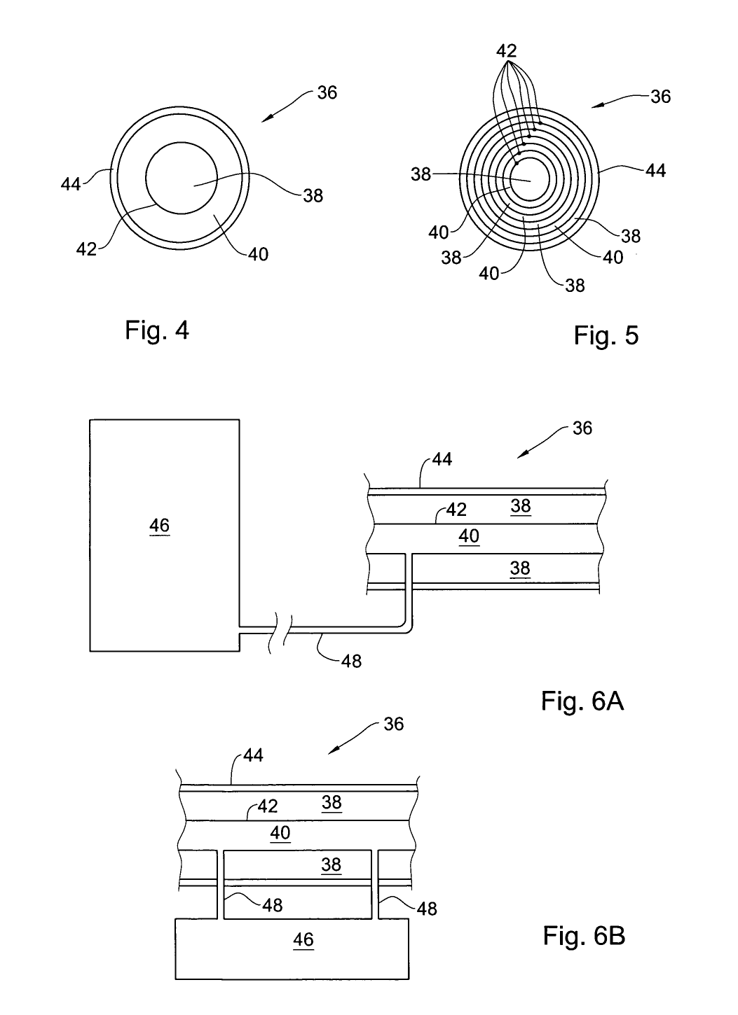

The main supply header pipe 36 may comprise a single storage element 40, or multiple storage elements, as illustrated in FIG. 3. In addition, it may be designed such that the supply chamber 38 is disposed within the storage element 40, as illustrated in FIG. 4. Alternatively, it may be designed such that it contains a plurality of supply chambers 38 and storage elements 40 nested within one another, as illustrated in FIG. 5.

According to any one of the above examples, the storage element 40 may extend along substantially the entire length of the main supply header pipe 36, in order to maximize the amount of thermal energy storage.

In addition, as illustrated in FIGS. 6A and 6B, the storage element 40 may be in communication with an external storage tank 46 to exchange thermal energy therewith, for example via one or more ducts 48 which bring the storage element in fluid communication with the external storage tank. In the event that more than one duct 48 is provided, some may be used for carrying thermal storage medium from the storage element 40 to the external storage tank 46, and others may be used for carrying thermal storage medium from the external storage tank to the storage element. Alternatively, a heat exchange system (not illustrated) may be provided which allows for thermal energy transfer between the storage element 40 and the external storage tank 46 without fluid exchange of thermal storage medium therebetween.

Providing an external storage element 46 as described above allows for increasing the amount of thermal storage medium in the solar thermal power plant 10, and thus increasing the amount of thermal energy which can be stored, without disconnecting and/or replacing the main supply header pipe 36. The external tank may be located beside the main supply header pipe 36, as illustrated in FIG. 6A, below it, as illustrated in FIG. 6B, or in any other appropriate configuration. Appropriate ancillary elements, such as pumps, sensors, etc., are provided as necessary.

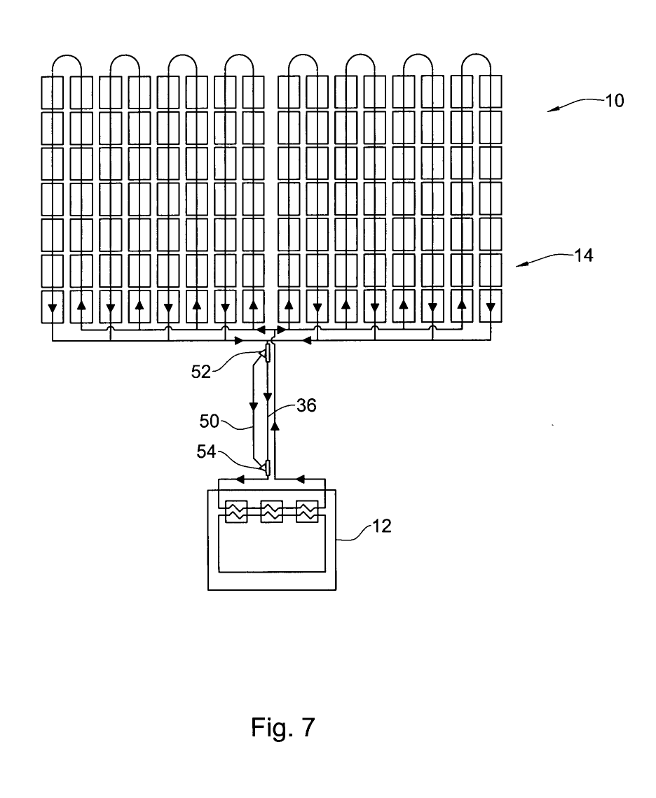

As illustrated in FIG. 7, a bypass pipe 50 may be provided. The bypass pipe 50 is connected to the main supply header pipe 36 such that fluid diverted thereto is substantially thermally isolated from the storage element 40. Thermal transfer fluid may thus flow from the solar collection system 14 to the thermal-electric power plant 12 via the bypass pipe 50 without adding thermal energy to or drawing thermal energy from the thermal storage medium. Inlet and outlet control valves 52, 54 are provided to regulate flow, i.e., to divert flow between the main supply header pipe 36 and the bypass pipe 50. In addition, a controller and appropriate sensors, such as temperate sensors, flow sensors, etc. (not illustrated) may be provided in order to operate the control valves 52, 54 to achieve desired operation.

Providing a bypass pipe 50 such as described above may be useful, for example, in a situation where it is determined that all of the heat captured from sunlight impinging on the solar collection system 14 should be used for driving the thermal-electric power plant 12, without any being drawn for thermal energy storage.

In use, the solar thermal power plant 10 may operate in one of a direct solar mode and a solar discharge mode.

In the direct solar mode, thermal transfer fluid flows through the tube radiation absorbers 26. The trough collectors 28 concentrate incident solar radiation on the tube radiation absorbers 26, thereby heating the thermal transfer fluid therein. The thermal transfer fluid flows through the local supply header pipe 32 and into the main supply header pipe 36, where some of the thermal energy is transferred through the wall 42 thereof and stored in the thermal storage medium within the storage element 40. The thermal transfer fluid then flows into the steam generation system 16 of the thermal-electric power plant 14, where the thermal energy thereof is transferred, via the heat exchangers 18, 20, 22, to the working fluid of the thermal-electric power plant, thereby driving its operation to produce electricity, as is well known. The thermally depleted thermal transfer fluid flows through the main return header pipe 34 and the local return header pipe 30, where it is distributed among the tube radiation absorber 26, wherein the process begins again.

During the direct solar mode, the control valves 52, 54 of the bypass pipe 50 may be operated to selectively divert thermal transfer fluid to the bypass pipe, as described above.

In the solar discharge mode, the path taken by the thermal transfer fluid is the same as described in connection with direct solar mode. However, as no incident solar radiation is available to provide thermal energy to the thermal transfer fluid, thermal energy which had been stored in the thermal storage medium within the storage element 40 of the main supply header pipe 36 provides the required heating to the thermal transfer fluid to enable it to drive the operation of the thermal-electric power plant.

The solar thermal power plant 10 may operate in other modes, or modified versions of the above modes, as appropriate.

It will be appreciated that while the solar thermal power plant 10 has been described above as comprising a main supply header pipe 36 provided as a dual-purpose pipe, any fluid pipe or line thereof (e.g., the local supply header pipe 32, the tube radiation absorbers 26, etc.) may be so provided without departing from the spirit and scope of the present invention, mutatis mutandis.

Those skilled in the art to which this invention pertains will readily appreciate that numerous changes, variations and modifications can be made without departing from the scope of the invention mutatis mutandis.

1.-51. (canceled)

52. A solar thermal power plant, comprising:
a thermal-electric power plant; and
a solar collection system in communication with the thermal-electric power plant to provide heat thereto for driving the operation of the thermal-electric power plant, the solar collection system facilitating capture of thermal energy of incident solar radiation by a thermal transfer fluid flowing therethrough for providing the heat, the solar collection system comprising:
one or more solar collectors configured for the capture; and
at least one dual-purpose pipe configured for carrying heated thermal transfer fluid to the thermal-electric power plant, the at least one dual-purpose pipe comprising:
a supply chamber for carrying the thermal transfer fluid therethrough, and
at least one storage element in thermal communication with the supply chamber, and being configured for storing thermal energy for providing heat for driving operation of the thermal-electric power plant.

53. The solar thermal power plant according to claim 52, configured to selectively operate in one of:
a direct solar mode, wherein the thermal transfer fluid is heated within the solar collection system by incident solar radiation, the heated thermal transfer fluid flowing therefrom via the supply chamber to the thermal-electric power plant to provide heat thereto to drive its operation, and used to heat the storage element; and
a solar discharge mode, wherein the thermal transfer fluid is heated within the supply chamber by the heated storage element.

54. The solar thermal power plant according to claim 52, configured to facilitate heating of the storage element by the thermal transfer fluid flowing to the thermal-electric power plant via the supply chamber.

55. The solar thermal power plant according claim 52, wherein the supply chamber and the storage element of the at least one dual-purpose pipe are arranged concentrically.

56. The solar thermal power plant according to claim 52, wherein the at least one dual-purpose pipe comprises a plurality of storage elements disposed within a single supply chamber.

57. The solar thermal power plant according to claim 52, wherein each of the supply chamber and the at least one storage element extends along substantially the entire length of the at least one dual-purpose pipe.

58. The solar thermal power plant according to claim 52, wherein the at least one dual-purpose pipe is thermally insulated.

59. The solar thermal power plant according to claim 52, wherein the solar collectors comprise parabolic solar concentrators having a tube radiation absorber for carrying thermal transfer fluid to be heated by the captured incident solar radiation.

60. The solar thermal power plant according to claim 59, wherein the tube radiation absorber is in fluid communication with the at least one dual-purpose pipe.

61. The solar thermal power plant according to claim 59, wherein the tube radiation absorber constitutes the at least one dual-purpose pipe.

62. The solar thermal power plant according to claim 52, wherein the at least one dual-purpose pipe is a header pipe configured for carrying heated thermal transfer fluid from the solar collection system to the thermal-electric power plant.

63. The solar thermal power plant according to claim 52, wherein the at least one dual-purpose pipe comprises at least one bypass pipe and control valves selectively configurable for bringing the solar collectors to fluid communication with the thermal-electric power plant via the bypass pipe such that heated thermal transfer fluid can be carried from the solar collectors to the thermal-electric power plant in thermal isolation from the storage element.

64. The solar thermal power plant according to claim 52, wherein the storage element of the at least one dual-purpose pipe comprises a storage chamber comprising a thermal storage medium therein in fluid isolation from the supply chamber.

65. The solar thermal power plant according to claim 64, wherein the thermal storage medium is selected from a group comprising sensible heat-storage material, phase-change storage material, and thermo-chemical storage media.

66. The solar thermal power plant according to claim 64, wherein the storage chamber is in communication with an external storage tank containing a thermal storage medium to facilitate exchange of thermal energy therewith.

67. The solar thermal power plant according to claim 66, wherein the storage chamber is in fluid communication with the external storage tank.

68. The solar thermal power plant according to claim 66, wherein the storage chamber is in thermal communication with the external storage tank.

69. A dual-purpose pipe for use with a solar thermal power plant, the solar thermal power plant comprising a thermal-electric power plant and a solar collection system in communication therewith to provide heat thereto for driving its operation and being designed to facilitate capturing of incident solar radiation by a thermal transfer fluid flowing therethrough for providing the heat, the solar collection system comprising one or more solar collectors configured for the capturing; the dual-purpose pipe being configured for carrying heated thermal transfer fluid to the thermal-electric power plant and comprising:
a supply chamber for carrying the thermal transfer fluid therethrough; and
at least one storage element in thermal communication with the supply chamber, and being configured for storing thermal energy for providing heat for driving operation of the thermal-electric power plant.

70. A method of generating electricity, comprising:
providing a solar thermal power plant comprising a thermal-electric power plant and a solar collection system in communication therewith to provide heat thereto for driving its operation, the solar collection system facilitating capture of thermal energy of incident solar radiation by a thermal transfer fluid flowing therethrough for providing the heat, the solar collection system comprising one or more solar collectors configured for the capture; and at least one dual-purpose pipe configured for carrying heated thermal transfer fluid to the thermal-electric power plant, the at least dual-purpose pipe comprising a supply chamber for carrying the thermal transfer fluid therethrough, and at least one storage element in thermal communication with the supply chamber for storing thermal energy for providing heat for driving operation of the thermal-electric power plant;
in a direct solar mode, causing the thermal transfer fluid to flow from the solar collection system to the thermal-electric power plant via the supply chamber, utilizing thermal energy captured within the solar collectors to heat the storage element and drive operation of the thermal-electric power plant; and
in a solar discharge mode, causing the thermal transfer fluid to flow through the supply chamber, utilizing the heated storage element to heat the thermal transfer fluid for driving operation of the thermal-electric power plant.
